(19) United States
(12) Patent Application Publication
(10) Pub. No.: US 2024/0260135 A1
(43) Pub. Date: Aug. 1, 2024

(54) TECHNOLOGIES FOR TIMER-BASED MULTICAST RECEPTION IN INACTIVE STATE

(71) Applicant: APPLE INC., CUPERTINO, CA (US)

(72) Inventors: Fangli Xu, Beijing (CN); Haijing Hu, Los Gatos, CA (US); Peng Cheng, Beijing (CN); Yuqin Chen, Beijing (CN)

(73) Assignee: APPLE INC., CUPERTINO, CA (US)

(21) Appl. No.: 18/545,397

(22) Filed: Dec. 19, 2023

Related U.S. Application Data
(60) Provisional application No. 63/442,361, filed on Jan. 31, 2023.

(51) Int. Cl. H04W 76/40; H04W 36/08; H04W 76/19; H04W 76/20

(52) U.S. Cl. CPC H04W 76/40; H04W 36/08; H04W 76/19; H04W 76/20

(57) ABSTRACT

The present application relates to devices and components, including apparatus, systems, and methods for inactive multicast reception using a timer. The user equipment (UE) may use a timer to monitor the multicast reception while in an inactive state.

### CROSS-REFERENCES TO OTHER APPLICATIONS

This application claims priority to U.S. Provisional Application No. 63/442,361, for “TECHNOLOGIES FOR TIMER-BASED MULTICAST RECEPTION IN INACTIVE STATE,” filed on Jan. 31, 2023, which is herein incorporated by reference in its entirety for all purposes.

### TECHNICAL FIELD

This application generally relates to cellular communication networks and, in particular, technologies for receiving multicast data in an inactive state.

### BACKGROUND

The use cases for multicast-broadcast services (MBS) over a cellular wireless network include public safety, vehicular communication applications, internet protocol television (IPTV), live video, software delivery over wireless, and Internet of Things (IoT) applications. Efficient and reliable delivery of these MBS services is desired.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates a signaling diagram in accordance with some embodiments.

FIG. 4 illustrates an operational flow/algorithmic structure in accordance with some embodiments.

FIG. 5 illustrates an operational flow/algorithmic structure in accordance with some embodiments.

FIG. 6 illustrates a user equipment in accordance with some embodiments.

FIG. 7 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

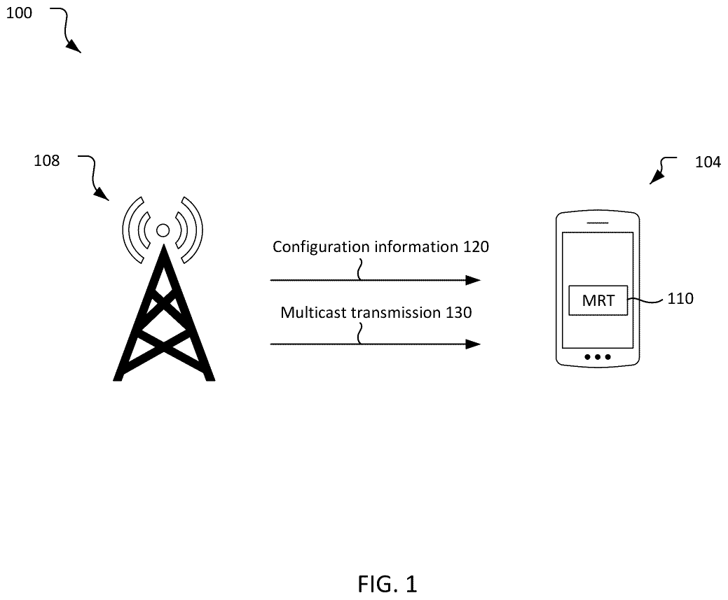

FIG. 1 illustrates a network environment 100 in accordance with some embodiments. The network environment 100 may include the UE 104 coupled with the base station (BS) 108 of a radio access network (RAN). The BS 108 may send the configuration information 120 to configure the state of the UE 104, the multicast session associated with the multicast transmission 130, the reception of the multicast transmission 130 at the UE 104, and the multicast reception timer (MRT) 110 at the UE 104.

In some embodiments, the BS 108 may be a next-generation node B (gNB) that provides one or more 3GPP New Radio (NR) cells, an evolved node B (eNB) that provides one or more Long Term Evolution (LTE) cells, or another type of BS that provides a later-generation, e.g., a Sixth Generation (6G) serving cell. The air interface over which the UE 104 and the BS 108 communicate may be compatible with 3GPP technical specifications (TSs), such as those that define 5G NR or later system standards (e.g., 6G standards).

The network environment 100 may provide a multicast-broadcast service (MBS). The MBS service may include a broadcast communication service in which the BS 108 transmits data to all participating UEs in a broadcast service area. The MBS service may include a multicast communication service, in which the BS 108 transmits data to a dedicated set of UEs authorized to receive the data.

The UE 104 and a data network (DN) exchange data via the BS 108 using an end-to-end user plane connectivity between the UE 104 and the DN. The end-to-end user plane connectivity may be referred to as a session or a packet data unit (PDU) session. The end-to-end connectivity for transporting MBS data may refer to an MBS session. The network may activate or deactivate an MBS session. To activate or deactivate an MBS session, the BS 108 sends an activation or deactivation message to the UE 104. An activation message may be called an activation notification. A deactivation message may be called a deactivation notification. The activation procedure activates the resources allocated for the MBS session, and the activation message indicates that the UE 104 may receive MBS data. The deactivation procedure releases the resources allocated for the MBS session and indicates to the UE 104 that it may not receive the MBS data.

Different layers of a protocol stack may need to be configured to establish an end-to-end session, for example, the radio resource control (RRC) layer, Layer 2 (L2) layer (including, e.g., medium access control (MAC), radio link control (RLC), and packet data convergence protocol (PDCP) sublayers), and the physical access (PHY) layer. The RRC configuration may provide several alternative states to the UE 104. In one alternative, the UE 104 may be in an RRC connected state (or an RRC connected mode), in which the UE 104 is configured and enabled to send and receive information. A UE in an RRC connected state may also be called a connected UE. In another alternative, the UE 104 may be in an RRC inactive state (or an RRC inactive mode), in which the UE 104 may receive information from the BS 108 but may not send information to the BS 108. A UE in an RRC inactive state may also be called inactive UE, e.g., inactive UE 104. In a third alternative, the UE 104 may be in an RRC idle state (or an RRC idle mode), where the UE 104 can only receive limited signals and channels, e.g., paging or broadcast channels. A UE in an RRC idle state may also be called idle UE. An idle UE may camp on a cell provided by the BS 108. While camping on a cell, the UE 104 is ready to initiate a potential dedicated service or to receive an ongoing MBS service. The UE 104 may transition from one RRC state to another via configuration signaling that may be generated by the UE 104 or by the BS 108. In one example, the UE 104 may transition from one RRC state to another in accordance with the 3GPP standards specifications.

In one instance, the UE 104 may be in an RRC connected state, and the network or the BS 108 may authorize the UE 104 to join a multicast session. The BS 108 sends an RRC reconfiguration message with the relevant MBS configuration for the multicast session to the UE 104. When the multicast session for the UE 104 is terminated, the BS 108 sends a multicast session deactivation message to the UE 104. After termination of the multicast reception, and in the absence of other ongoing data sessions, the BS 108 may release the UE 104 to an RRC idle or an RRC inactive state.

In legacy networks, when the UE 104 is in an RRC idle or an RRC inactive state, the UE 104 may not be able to receive multicast data. The UE 104 must transition to an RRC connected state before receiving multicast data. When in an RRC idle or inactive state, the UE 104 monitors whether the BS 108 sends any message on the paging channel. The BS 108 sends the multicast session activation message using the paging mechanism. The paging message may contain the MBS session identification (ID) to identify the MBS session. When the UE 104 is in an RRC inactive state and in response to a paging message with an MBS session ID, the UE 104 may initiate an RRC resume procedure to receive the MBS session after transitioning to an RRC connected state. When the UE 104 is in an RRC idle state and in response to a paging message with an MBS session ID, the UE 104 may initiate the RRC setup procedure and the RRC reconfiguration to receive the MBS session after transitioning to an RRC connected state. The BS 108 may send a paging message to a group of UEs or page each UE individually.

The UE 104 in an RRC connected state may provide feedback to the BS 108 about the MBS multicast transmission. Based on the feedback, the BS 108 may adjust the UE 104 configuration to meet the quality of service (QoS) requirements. For example, the UE 104 may send the channel state information of the MBS channel to the BS 108.

In one embodiment, the UE 104 may receive MBS multicast transmissions when the UE 104 is in an RRC inactive state. The BS 108 may configure the UE 104 for multicast reception in an RRC inactive state. The BS 108 may send a multicast activation notification to the UE 104 to indicate that the UE 104 may join a multicast session. The BS 108 may send a multicast deactivation notification to the UE 104 to indicate the termination of the multicast session to the UE 104. The BS 108 may send activation or deactivation notifications via explicit signaling, e.g., an RRC signaling or a broadcast channel signaling.

The UE 104 in an RRC inactive state may not be able to transmit information in the uplink (UL). For example, the UE 104 may not provide feedback to the BS 108 about the MBS service, such as multicast channel quality or multicast transmission block error rate (BLER). Due to the lack of feedback from an RRC inactive UE 104, the BS 108 may not adjust the MBS multicast transmission and reception configuration.

Moreover, when the UE 104 does not receive multicast data from an activated MBS multicast session, the UE may not distinguish whether the BS 108 has not sent multicast data or the UE 104 has not received it, e.g., because of a bad channel. A bad channel may be a channel with a signal-to-noise ratio that is less than a predefined threshold. For example, the BS 108 may deactivate the multicast session, but the UE 104 may not receive the deactivation notification in a timely manner. The UE 104 continues monitoring the MBS channel for multicast reception, while the BS 108 does not send any multicast data to the UE 104. Furthermore, when the inactive UE 104 has a problem receiving multicast data, the BS 108 may not receive any notification about the UE's reception, and it may not instruct the UE 104 to stop the multicast reception while in an RRC inactive state. Requiring the inactive UE 104 to continue to monitor the multicast reception in this state may waste the battery power and cause an undesirable quality of experience, e.g., data reception failure and service interruption.

In accordance with some embodiments, the UE 104 may use the MRT 110 to monitor and control the multicast reception. The BS 108 may send the configuration information 120 to the UE 104 using shared or dedicated signaling or messages and through control or data channels. The configuration information 120 may cause the UE 104 to become an inactive UE. The configuration information 120 may enable the UE 104 to receive multicast transmission 130 in an inactive state. The configuration information 120 may configure the UE 104 for receiving multicast transmission 130 of a multicast session. The configuration information 120 may configure the MRT 110 and associate it with the UE 104 or the multicast session. When the multicast session is activated, the UE 104 may start the MRT 110. The UE 104 receives the multicast transmission 130 while the MRT 110 is running. The UE 104 may stop reception of multicast transmission 130 when the MRT 110 expires or stops.

The BS 108 may configure the MRT 110 at the UE 104. The BS 108 may use a dedicated RRC message (or signaling) or a broadcast message to configure the MRT 110 at the UE 104. For example, the BS 108 may send an RRC release with suspend message to the UE 104. Receiving the RRC release with suspend message may cause the UE 104 to enter the RRC inactive state. The RRC release with suspend message may configure the UE to receive the multicast data (or multicast transmissions) in RRC inactive state. Furthermore, the RRC release with suspend message may configure the MRT 110.

In some embodiments, the MRT 110 may be configured on a per-UE basis. For example, the BS 108 may configure one MRT for the UE 104. The UE 104 monitors the multicast reception for all the UE's multicast sessions based on the one MRT. For example, if the UE 104 receives multicast transmissions from two multicast sessions, the single configured MRT may be used as a basis to monitor multicast reception on both multicast sessions.

In some embodiments, the MRT 110 may be configured on a per-multicast-session basis. For example, the BS 108 may configure one MRT for each multicast session. If the UE 104 receives multicast transmissions from two separate multicast sessions, the UE 104 monitors the multicast reception from the first multicast session based on a first MRT and the second multicast session based on a second (and a different) MRT.

The UE 104, enabled and configured to receive multicast reception in an RRC inactive state, operates and maintains the configured MRTs while camping on a cell. When the inactive UE 104 switches to a new cell, the UE 104 may stop the configured and operational MRTs. The UE 104 may receive configuration from the new cell to operate and maintain MRTs. The operation and maintenance of the MRT 110 may be based on all the multicast sessions configured at the UE 104. Alternatively, the operation and maintenance of the MRT 110 may be based on the multicast session associated with the MRT 110.

The inactive UE 104 may detect a trigger event associated with receiving multicast transmissions of a multicast session. The inactive UE 104 may start the MRT 110 based on the detection of the trigger event. The trigger event may be a condition, indication, signal, or message that causes the inactive UE 104 to start, reset, restart, or stop the MRT 110. The trigger event that starts the MRT 110 may differ from the trigger event that restarts the MRT 110. A trigger event may be associated with a time point at which the trigger event occurs or is detected.

The MRT 110 may run for a predefined duration; if it is not started, reset, restarted, or stopped, the MRT 110 will expire. In one instance, when the MRT 110 restarts, the MRT 110 may run for the remainder of its predefined duration before it expires. In one instance, when the MRT 110 restarts, the MRT 110 may run for the predefined duration before it expires. The BS 108 may configure the predefined duration for the MRT 110. Configured MRTs in the inactive UE 104 may be configured with the same predefined duration or different predefined durations. For example, a single value may define the duration for all configured MRTs in the inactive UE 104. The predefined duration of an MRT may be a static or semi-static value. The BS 108 may change a semi-static predefined duration via reconfiguration operation.

The MRT 110 continues running (or may restart) while the UE 104 receives multicast data. For example, while the MRT 110 is running, the UE 104 monitors the physical downlink control channel (PDCCH) for multicast scheduling and resource allocation information or receives the multicast data on the physical downlink shared channel (PDSCH). When the MRT 110 stops, the inactive UE 104 may stop monitoring and receiving the multicast data.

The BS 108 may configure the trigger events at the inactive UE 104, or the 3GPP TSs may define the trigger events. In one instance, the inactive UE 104 may detect a trigger event associated with receiving a multicast transmission of a multicast session. For example, the trigger event for starting or restarting the MRT 110 may be one or more of the following options.

Option one for the starting or restarting trigger event is when the UE 104 enters an RRC inactive state following the reception of the configuration that enables the UE 104 to receive multicast transmission in an RRC inactive state. The inactive UE 104 may start the MRT 110 whether or not the multicast session is activated, e.g., whether the inactive UE 104 has received a multicast session activation notification.

Option two for the starting or restarting trigger event is when the session is activated. For example, the starting or restarting trigger event is when the UE 104 receives the multicast session activation notification while the UE 104 is in an RRC inactive state.

Option three for the starting or restarting trigger event is when the inactive UE 104 receives the multicast data scheduling. The BS 108 may send the multicast data scheduling on PDCCH.

Option four for the starting or restarting trigger event is when the inactive UE 104 receives the multicast data or the multicast transmission. In a variation of this option, the trigger event is when the inactive UE 104 successfully receives the multicast data, e.g., the multicast transmission is successfully decoded at the inactive UE 104.

Option five for the starting or restarting trigger event is when the inactive UE 104 camps on a new cell in an RRC inactive state, and the multicast session is activated in the new cell for inactive UE 104. When the multicast session is activated in the new cell before cell reselection, the trigger event is when the UE 104 completes the cell reselection to the new cell and camps on the new cell in an RRC inactive state. When the multicast session is activated in the new cell after the cell reselection, the trigger event is when the inactive UE 104 receives the multicast session activation notification in the new cell.

The options for start and restart trigger events are not mutually exclusive. The BS 108 may configure the UE 104 to implement one or more of the start and restart trigger events. In some instances, the UE 104 may be configured to use a trigger event for starting the MRT 110 that differs from the trigger event for restarting the MRT 110. The UE 104 may be configured to use the same trigger events for starting and restarting the MRT 110.

For options one to five above, the inactive UE 104 may delay starting the timer for a predefined amount of time. The predefined amount of time may be defined by the 3GPP standard or configured by the BS 108. Furthermore, the inactive UE 104 may apply the delayed start following any starting and restarting trigger events.

The UE 104 may detect a trigger event associated with the receiving multicast transmission of a multicast session that causes the UE 104 to stop the MRT 110. The trigger event for stopping the MRT 110 may be one or more of the following options.

Option one for the stopping trigger event is when the inactive UE 104 receives the configuration to enable the UE 104 to receive multicast transmission of a previously deactivated multicast session. The UE 104 may receive the configuration that enables multicast reception in the RRC release message. The UE 104 may receive the status of the multicast session via dedicated or shared signaling, e.g., the RRC configuration message.

Option two for the stopping trigger event is when the inactive UE 104 receives the multicast session deactivation notification.

Option three for the stopping trigger event is when the inactive UE 104 successfully moves or camps on another cell via the selection or reselection procedure. In one instance, option three for the stopping trigger event and option five for the starting or restarting trigger events may be implemented together. For example, when the UE 104 leaves the source cell and moves to a target cell, the inactive UE 104 may stop the MRT 110 corresponding to the source cell and starts the MRT 110 corresponding to the target cell. An MRT corresponds to a cell when it receives its configurations from that cell. The multicast session may be the same, e.g., having the same MBS or multicast session ID, in both source and target cells.

Option four for the stopping trigger event is when the UE 104 enters an RRC connected or idle state. For example, the inactive UE 104 may receive a release message from the BS 108. The release message may cause the inactive UE 104 to transition to an RRC idle state. The BS 108 may trigger the transition of the inactive UE 104 to an RRC connected by the paging process. The inactive UE 104 may trigger the transition to an RRC connected by sending a resume request message to the BS 108.

Option five for the stopping trigger event is when the MRT 110 expires. The MRT 110 expires when it runs, without being reset or renewed, for the predefined duration.

The options for the stopping trigger events are not mutually exclusive. The BS 108 may configure the UE 104 to use one or more of the stopping trigger events.

The UE 104 may receive the multicast transmission of the multicast session prior to the expiration or stopping of the MRT 110. When the MRT 110 stops based on a stopping trigger event, the UE 104 may stop the multicast data reception in the camping cell. Upon stopping the MRT 110, the UE 104 may check parameters or conditions to identify and report a possible cause for stopping the MRT 110.

In one instance, the UE 104 may check the multicast channel quality and compare it with a preconfigured threshold. For example, the UE 104 may measure the reference signal received power (RSRP) and compare it against a preconfigured RSRP threshold. In another example, the UE 104 may measure the number of multicast packets that the UE 104 failed to decode and compare it to a failed packet threshold. In another example, the UE 104 may measure the block error rate (BLER) and compare it against the preconfigured BLER threshold.

Based on the UE 104 check of conditions and parameters, e.g., a determination that the RSRP is less than the RSRP threshold or the BLER is greater than the BLER threshold, the UE 104 may trigger the RRC resume procedure to transition the UE 104 from an RRC inactive state to an RRC connected state. When the UE 104 enters an RRC connected state, it may log, record, and report the events and conditions causing the UE 104 to transition to an RRC connected state. For example, the UE 104 may record the MRT 110 stopping and also log and record the timestamp of the MRT 110 stopping, the RSRP value, the number of failed decoded packets, or channel quality at the time of the MRT 110 stopping. The UE 104 may report the events to the BS 108 via logged minimization of drive test (loggedMDT) report or quality of experience (QoE) reporting in accordance with 3GPP standards specifications.

In some instances, the MRT 110 may run for the preconfigured duration and expire. When the MRT 110 expires, the UE 104 may stop the multicast data reception in the camping cell. Upon expiration of the MRT 110, the UE 104 may check parameters or conditions to identify and report a possible cause for the MRT 110 expiration. For example, determining whether not receiving multicast transmission 130 at the UE 104 is due to bad channel quality.

Based on the UE 104 check of conditions and parameters, e.g., a determination that the RSRP is less than the RSRP threshold or the BLER is greater than the BLER threshold, the UE 104 may trigger the RRC resume procedure to transition the UE 104 from an RRC inactive state to an RRC connected state. When the UE 104 enters an RRC connected state, it may log, record, and report the events causing the UE 104 to transition to an RRC connected state. For example, the UE 104 may record the MRT 110 expiry and also log and record the timestamp of the MRT 110 expiry, the RSRP value, the number of failed decoded packets, or channel quality at the time of the MRT 110 expiry. The UE 104 may report the events to the BS 108 via logged minimization of drive test (loggedMDT) report or quality of experience (QoE) reporting in accordance with 3GPP standards specifications.

The BS 108 may reconfigure the MRT 110 of the inactive UE 104. For example, based on the UE's report or the UE's request for changing its RRC state, the BS 108 may reconfigure the MRT 110 after a timer expiry or stopping. In one instance, the network, e.g., the BS 108, may reconfigure the MRT 110 via the RRC dedicated signaling. An RRC dedicated signaling may be a message sent to the UE 104 and may not be decoded by other UEs. In another instance, the BS 108 may reconfigure the MRT 110 via multicast or broadcast channels, e.g., the multicast control channel (MCCH). The reconfiguration may change the duration of the MRT 110 or may modify the trigger event for starting, restarting, or stopping the MRT 110. The reconfiguration may associate the MRT 110 to a multicast session by assigning the MRT 110 to an MBS session ID or a multicast session ID.

The BS 108 may reconfigure the MRT 110 using an RRC dedicated signaling (or an RRC dedicated message). For example, in response to the MRT 110 expiry or stopping, the inactive UE 104 may request RRC reconnection, and the BS 108 may include a new MRT configuration in response to the UE's request. For example, the inactive UE 104 may send an RRC resume request message to the BS 108 to initiate the transition from an RRC inactive state to an RRC connected state. In response to the RRC resume request message, the BS 108 may send an RRC release message, e.g., an RRC release with suspend configuration message. The RRC release with suspend configuration message keeps the UE 104 in an RRC inactive state. The BS 108 may reconfigure the MRT 110 by including an MRT configuration in the point-to-multipoint (PTM) configuration of the RRC release message.

The inactive UE 104 may start the MRT 110 after receiving reconfiguration from the BS 108. For example, when the inactive UE 104 receives the RRC release message with multicast PTM configuration, the UE 104 may immediately start the MRT 110 if the multicast session is activated. The UE 104 may receive the status of the multicast session, the multicast session being active, in the RRC release message, or in an activation notification message. Alternatively, the inactive UE 104 may start the MRT 110 after receiving or detecting a start or restart trigger event. If the multicast session is deactivated when the BS 108 reconfigures the MRT 110, the UE 104 may start the timer at a start or restart trigger event or at one of the following three trigger event options.

In option one, the UE 104 may start the MRT 110 for a deactivated multicast session after receiving MRT reconfiguration when the multicast session is activated. The UE 104 may receive multicast session activation notification or an indication in the RRC signaling.

In option two, the UE 104 may start the MRT 110 for a deactivated multicast session after receiving MRT reconfiguration when the UE 104 receives the first multicast data after the session is activated.

In option three, the UE 104 may start the MRT 110 for a deactivated multicast session after receiving MRT reconfiguration when the UE 104 successfully receives the first multicast data after the multicast session is activated.

The BS 108 may reconfigure the MRT 110 using signaling on the broadcast control channel (BCCH) or the multicast control channel (MCCH). For example, the BS 108 may send the PTM configuration to the UE 104 through MCCH. The PTM configuration may configure or reconfigure the MRT 110. The inactive UE 104 may start the reconfigured MRT 110 when detecting one of the following three trigger events.

In option one, the inactive UE 104 may start the reconfigured MRT 110 at the current or next starting point of the MCCH modification period as defined and described in the 3GPP specification. The modification period may be when the system information block (SIB) remains unchanged. The BS 108 may reconfigure (or configure) the MRT 110 using SIB.

In option two, the inactive UE 104 may start the reconfigured MRT 110 when the inactive UE 104 receives the first scheduled multicast data according to the configured multicast transmission schedule.

After the UE 104 receives PTM and multicast configuration and before receiving the starting trigger event, the UE 104 may monitor or receive the multicast configuration according to the PTM configuration. The UE 104 may monitor PDCCH for the multicast configuration. The UE 104 may receive the multicast configuration on PDCCH or PDSCH.

In option three, the inactive UE 104 may start the reconfigured MRT 110 when the inactive UE 104 successfully receives the first multicast data after the session is activated.

In one instance, the inactive UE 104 may move from a source cell and reselect and camp on another cell, e.g., a target cell. For example, the UE 104 may be mobile and move to another cell. The operation of the MRT 110 after cell reselection may depend on whether the UE 104 continues receiving the multicast service in the new cell.

In one instance, the UE 104 may receive the multicast configuration in the source cell, and while still in the source cell, the UE 104 may determine that the multicast session is activated in the target cell. For example, as part of the multicast configuration, the UE 104 may receive a list of target cells or neighboring cells in which the multicast session is activated. The multicast configuration may also provide the configuration of the multicast session in the target cell or neighboring cells. For example, the multicast session may have the same configuration in the source and target cells. Reselecting the target cell and camping on the target cell may be a restarting trigger event, and the UE 104 may restart the timer upon completing a successful reselection. The inactive UE 104 may also restart the timer based on other trigger events. After the reselection, the UE 104 may monitor the control channel for the multicast scheduling information.

The UE 104 in the source cell may receive a configuration for the multicast session in a target cell that differs from the multicast session configuration in the source cell. The UE 104 may also determine that the multicast session is deactivated in the target cell before switching to the target cell. For example, after completing the cell reselection, the UE 104 may start the timer (or restart the timer) when the inactive UE 104 receives an activation notification or an indication that the multicast session is activated. In another instance, the UE 104 may start the timer when the UE 104 receives the first multicast data after the multicast session is activated.

In one instance, the UE 104 may receive the multicast configuration in the new cell after switching from the source cell to the target cell. For example, the UE 104 receives the configuration from the broadcast or MCCH channel in the target cell or via a dedicated RRC message. For example, the MRT 110 operation may be similar to the MRT 110 operation after the reconfiguration described above.

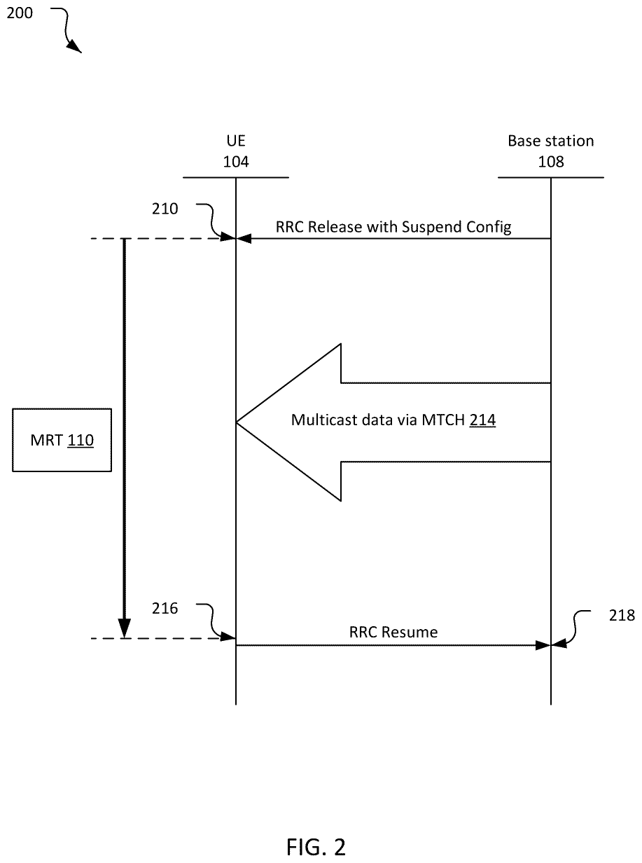

FIG. 2 illustrates a signaling diagram 200 in accordance with some embodiments. Signaling diagram 200 is an example of operations related to receiving multicast transmission using an MRT when the UE 104 is in an RRC inactive state.

At 210, the BS 108 sends, and the UE 104 receives, an RRC release with suspend config message. The RRC release with suspend configuration message includes configuration for an MRT, PTM configuration for receiving the multicast transmissions, and the multicast configurations. Moreover, the RRC release with suspend configuration message enables the inactive multicast MBS reception, e.g., multicast reception in an RRC inactive state. Furthermore, the RRC release with suspend configuration causes the UE 104 to enter (or remain in) an RRC inactive state. At 210, the UE 104 starts the MRT 110 in response to detecting a trigger event. For example, the trigger event may be receiving the configuration to enable the inactive multicast reception and entering the inactive state.

At 216, the MRT 110 expires. During the time between 210 and 216, the BS 108 sends, and the inactive UE 104 receives multicast data 214 via multicast transport channel (MTCH). After the expiration of the MRT 110, the UE 104 may determine whether the channel quality is less than a predetermined threshold. For example, the UE 104 may determine that the RSRP is less than a predetermined or preconfigured RSRP threshold.

At 218, based on the UE 104 determination, e.g., when the RSRP is less than a predetermined RSRP threshold, the UE 104 may send, and the BS 108 may receive, an RRC resume message. The UE 104 sends the RRC resume message to transition to an RRC connected to send a report to the BS 108 regarding the channel quality associated with the multicast session. The UE 104 may send the channel quality feedback to the BS 108 when the UE 104 is in an RRC connected state.

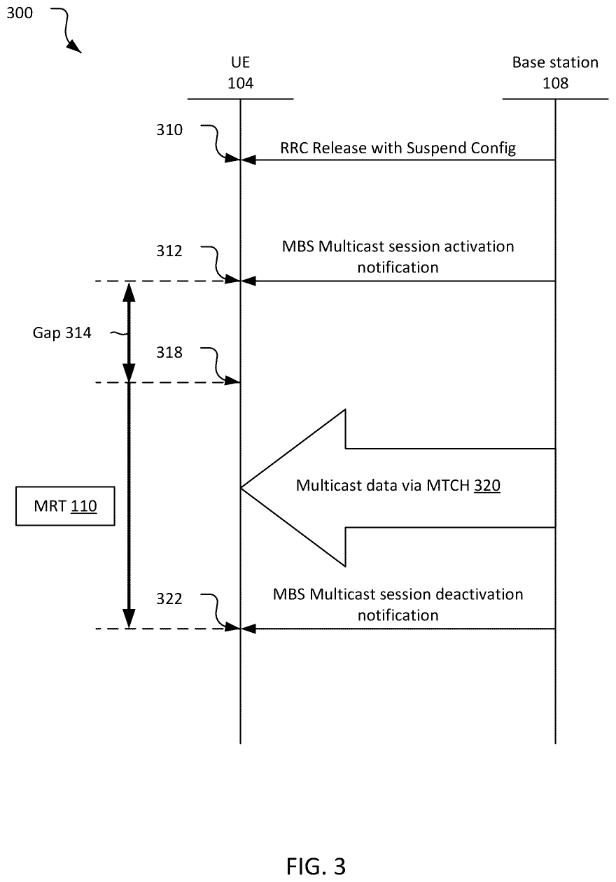

FIG. 3 illustrates a signaling diagram 300 in accordance with some embodiments. Signaling diagram 300 is an example of operations related to starting or stopping the MRT 110 based on the multicast session activation or deactivation.

At 310, the BS 108 sends, and the UE 104 receives, an RRC release with suspend config message. The RRC release with suspend config message includes configuration for an MRT, PTM configuration for receiving the multicast transmissions, and the multicast configurations. Furthermore, the RRC release with suspend configuration causes the UE 104 to enter (or remain in) an RRC inactive state. Moreover, the RRC release with suspend configuration message enable the inactive multicast MBS reception, e.g., multicast reception in an RRC inactive state. The configuration message may include an indication that the multicast session is deactivated.

At 312, the inactive UE 104 receives an MBS multicast session activation notification. The BS 108 may configure the receipt of multicast session activation notification to be the trigger event for starting the MRT 110 at the UE 104. Moreover, the BS 108 may configure the UE 104 to delay starting the MRT 110 by a predefined amount of time, e.g., x milliseconds, where the network configures x. The time duration between 312 and 318 is the gap 314 in which the UE 104 delays the start of the MRT 110.

At 318, the gap 314 ends, and the inactive UE 104 starts the MRT 110. During the time between 312 and 322, the UE 104 receives multicast data 320 via MTCH.

At 322, the BS 108 sends, and the inactive UE 104 receives the MBS multicast session deactivation notification. Receiving the multicast session deactivation notification may be configured as the stopping trigger event for the MRT 110. The inactive UE 104 stops the MRT 110 at 322 based on receiving the multicast session deactivation notification.

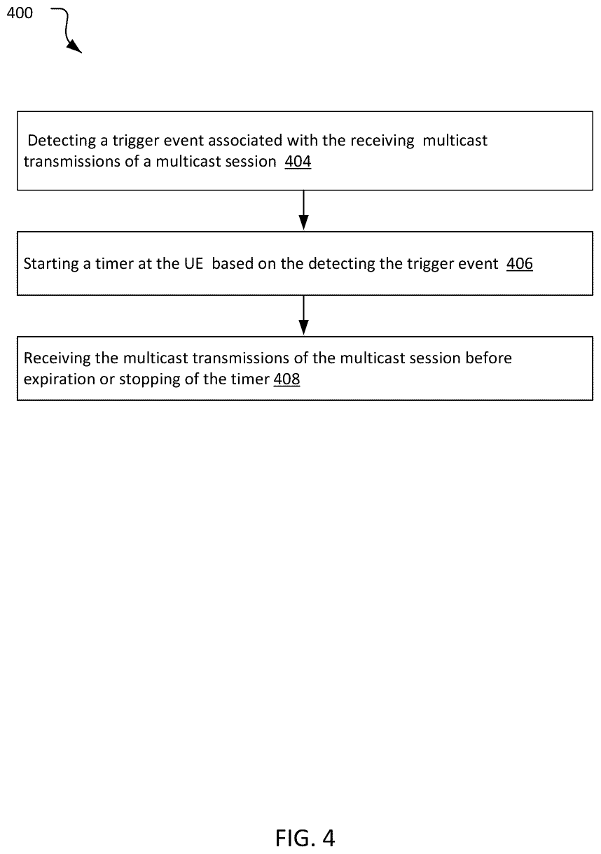

FIG. 4 illustrates an operational flow/algorithmic structure 400 in accordance with some embodiments. Flow diagram 400 is an example of a process for a UE receiving multicast data while in an RRC inactive state using a timer. The operational flow/algorithmic structure 400 may be implemented by a UE such as, for example, UE 104 or UE 600 or components thereof, e.g., processors 604.

At 404, the operational flow/algorithmic structure 400 includes detecting a trigger event associated with receiving multicast transmissions of a multicast session. Detecting the trigger event may occur while the UE is camped on a cell and in an RRC inactive state. The trigger event may be receiving a configuration to enable inactive multicast reception, activation notification, multicast data, entering an RRC inactive state, or camping on a new cell due to cell reselection.

At 406, the operational flow/algorithmic structure 400 includes starting a timer at the UE based on detecting the trigger event. The timer may be associated with the UE, where the UE uses the same timer for all of the multicast sessions that the UE joins. The timer may be associated with the multicast session, where each multicast session the UE joins may have a timer of its own. The BS may configure the timer to be associated with the UE or the multicast session.

At 408, the operational flow/algorithmic structure 400 includes receiving the multicast transmission of the multicast session before the expiration or stopping of the timer. The UE may detect a trigger event that causes the UE to stop the timer. For example, the trigger event that causes the UE to stop the timer may include timer expiration, receiving multicast session deactivation notification, receiving an indication that the multicast session is deactivated, performing cell reselection, or entering an RRC connected or idle state.

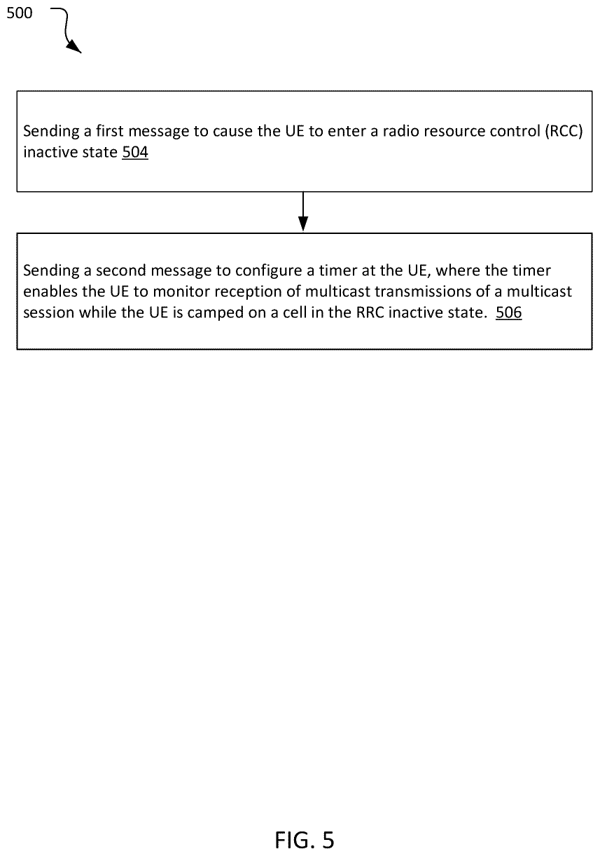

FIG. 5 illustrates an operational flow/algorithmic structure 500 in accordance with some embodiments. Flow diagram 500 is an example of a process for a BS to enable a UE to receive multicast data in an RRC inactive state using a timer. The operational flow/algorithmic structure 500 may be implemented by a BS such as, for example, BS 108 or BS 700 or components thereof, e.g., processors 704.

At 504, the operational flow/algorithmic structure 500 includes sending a first message to cause the UE, e.g., UE 104 or UE 600, to enter an RRC inactive state. The first message may be an RRC release message that causes the UE to transition to an RRC inactive state or to stay in an RRC inactive state.

At 506, the operational flow/algorithmic structure 500 includes sending a second message to configure a timer at the UE, where the timer enables the UE to monitor the reception of multicast transmissions of a multicast session while the UE is camped on a cell in the RRC inactive state. The message also may enable and configure the inactive multicast reception at the UE.

The BS may configure the UE to use one timer for all multicast sessions or may configure a separate timer for each multicast session. The BS may use a dedicated RRC message for configuring the inactive multicast reception. The BS may use MCCH or SIB for configuring the inactive multicast reception. The BS may configure the UE for inactive multicast reception in the neighboring cells.

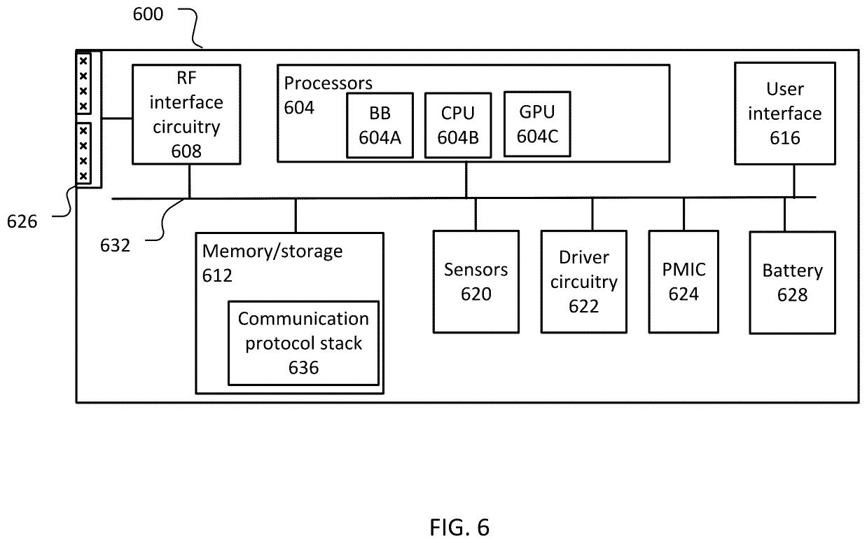

FIG. 6 illustrates a UE 600 in accordance with some embodiments. The UE 600 may be similar to and substantially interchangeable with UE 104 of FIG. 1.

The UE 600 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 600 may include processors 604, RF interface circuitry 608, memory/storage 612, user interface 616, sensors 620, driver circuitry 622, power management integrated circuit (PMIC) 624, the antenna structure 626, and battery 628. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangements of the components shown may occur in other implementations.

The components of the UE 600 may be coupled with various other components over one or more interconnects 632, which may represent any type of interface, input/output, bus (local, system, or expansion), transmission line, trace, or optical connection that allows various circuit components (on common or different chips or chipsets) to interact with one another.

The processors 604 may include processor circuitry such as, for example, baseband processor circuitry (BB) 604A, central processor unit circuitry (CPU) 604B, and graphics processor unit circuitry (GPU) 604C. The processors 604 may include any type of circuitry or processor circuitry that executes or otherwise operates computer-executable instructions, such as program code, software modules, or functional processes from memory/storage 612 to cause the UE 600 to perform operations as described herein.

The processors 604 may perform operations associated with inactive multicast reception using an MRT as described elsewhere herein. For example, the processors 604 may detect a trigger event and start, restart, or stop an MRT associated with a multicast session, or a UE based on the trigger event.

In some embodiments, the baseband processor circuitry 604A may access a communication protocol stack 636 in the memory/storage 612 to communicate over a 3GPP-compatible network. In general, the baseband processor circuitry 604A may access the communication protocol stack 636 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 608.

The baseband processor circuitry 604A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 612 may include one or more non-transitory, computer-readable media that includes instructions (for example, the communication protocol stack 636) that may be executed by one or more of the processors 604 to cause the UE 600 to perform various operations described herein. The memory/storage 612 includes any type of volatile or non-volatile memory that may be distributed throughout the UE 600. In some embodiments, some of the memory/storage 612 may be located on the processors 604 themselves (for example, L1 and L2 cache), while other memory/storage 612 is external to the processors 604 but accessible thereto via a memory interface. The memory/storage 612 may include any suitable volatile or non-volatile memory such as, but not limited to, dynamic random-access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 608 may include transceiver circuitry and a radio frequency front module (RFEM) that allows the UE 600 to communicate with other devices over a radio access network. The RF interface circuitry 608 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 626 and proceed to filter and amplify (with a low-noise amplifier) the signal. The signal may be provided to a receiver of the transceiver that down-converts the RF signal into a baseband signal that is provided to the baseband processor of the processor 604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 626.

In various embodiments, the RF interface circuitry 608 may be configured to transmit/receive signals in a manner compatible with NR access technologies.

The antenna 626 may include antenna elements to convert electrical signals into radio waves to travel through the air and to convert received radio waves into electrical signals. The antenna elements may be arranged into one or more antenna panels. The antenna 626 may have antenna panels that are omnidirectional, directional, or a combination thereof to enable beamforming and multiple input, multiple output communications. The antenna 626 may include microstrip antennas, printed antennas fabricated on the surface of one or more printed circuit boards, patch antennas, or phased array antennas. The antenna 626 may have one or more panels designed for specific frequency bands, including bands in FR1 or FR2.

The user interface circuitry 616 includes various input/output (I/O) devices designed to enable user interaction with the UE 600. The user interface 616 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 600.

The sensors 620 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 622 may include software and hardware elements that operate to control particular devices that are embedded in the UE 600, attached to the UE 600, or otherwise communicatively coupled with the UE 600. The driver circuitry 622 may include individual drivers allowing other components to interact with or control various I/O devices that may be present within or connected to the UE 600. For example, the driver circuitry 622 may include circuitry to facilitate the coupling of a universal integrated circuit card (UICC) or a universal subscriber identity module (USIM) to the UE 600. For additional examples, driver circuitry 622 may include a display driver to control and allow access to a display device, a touchscreen driver to control and allow access to a touchscreen interface, sensor drivers to obtain sensor readings of sensor circuitry 620 and control and allow access to sensor circuitry 620, drivers to obtain actuator positions of electro-mechanic components or control and allow access to the electro-mechanic components, a camera driver to control and allow access to an embedded image capture device, audio drivers to control and allow access to one or more audio devices.

The PMIC 624 may manage the power provided to various components of the UE 600. In particular, with respect to the processors 604, the PMIC 624 may control power-source selection, voltage scaling, battery charging, or DC-to-DC conversion.

In some embodiments, the PMIC 624 may control or otherwise be part of various power-saving mechanisms of the UE 600, including DRX, as discussed herein.

A battery 628 may power the UE 600, although in some examples, the UE 600 may be mounted and deployed in a fixed location and may have a power supply coupled to an electrical grid. The battery 628 may be a lithium-ion battery, a metal-air battery, such as a zinc-air battery, an aluminum-air battery, a lithium-air battery, and the like. In some implementations, such as in vehicle-based applications, the battery 628 may be a typical lead-acid automotive battery.

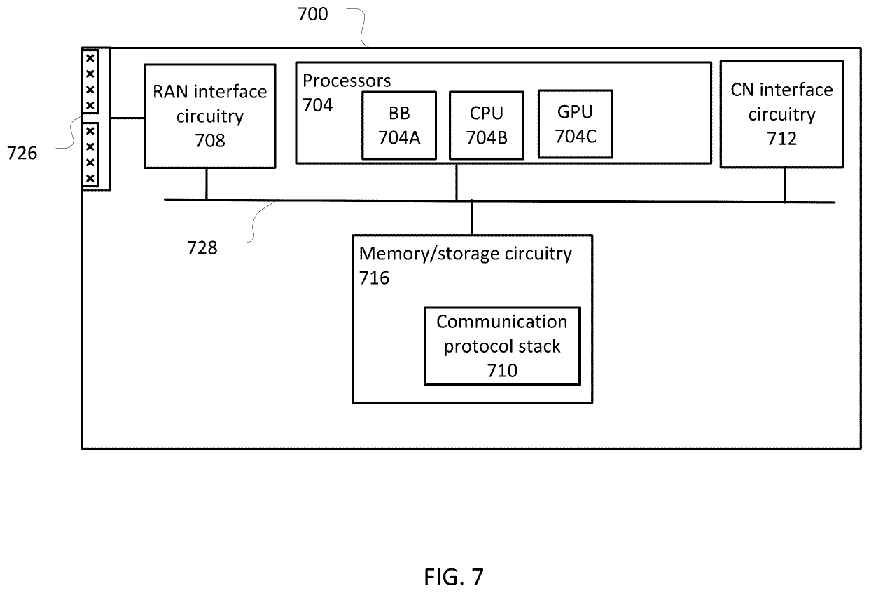

FIG. 7 illustrates a network node 700 in accordance with some embodiments. The network node 700 may be similar to and substantially interchangeable with base station 108, a device implementing one of the network hops, an integrated access and backhaul (IAB) node, a network-controlled repeater, or a server in a core network or external data network.

The network node 700 may include processors 704, RF interface circuitry 708 (if implemented as an access node), the core node (CN) interface circuitry 712, memory/storage circuitry 716, and antenna structure 726.

The components of the network node 700 may be coupled with various other components over one or more interconnects 728.

The processors 704, RF interface circuitry 708, memory/storage circuitry 716 (including communication protocol stack 710), antenna structure 726, and interconnects 728 may be similar to like-named elements shown and described with respect to FIG. 6.

The processors 704 may perform operations associated with the reception of inactive multicast transmissions at the UE using an MRT as described elsewhere herein. For example, the processors 704 may send messages to the UE to cause the UE to enter an RRC inactive state, to enable the inactive multicast reception at the UE, to configure multicast sessions in the cell and associated neighboring cells, or to configure an MRT associated with the UE or the multicast session.

The CN interface circuitry 712 may provide connectivity to a core network, for example, a 5th Generation Core network (5GC) using a 5GC-compatible network interface protocol such as carrier Ethernet protocols or some other suitable protocol. Network connectivity may be provided to/from the network node 700 via a fiber optic or wireless backhaul. The CN interface circuitry 712 may include one or more dedicated processors or FPGAs to communicate using one or more of the aforementioned protocols. In some implementations, the CN interface circuitry 712 may include multiple controllers to provide connectivity to other networks using the same or different protocols.

In some embodiments, the network node 700 may be coupled with transmit-receive points (TRPs) using the antenna structure 726, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method for receiving multicast transmission at a user equipment (UE), the method comprising: detecting a trigger event associated with receiving multicast transmissions of a multicast session while the UE is camped on a cell in a radio resource control (RRC) inactive state; starting a timer at the UE based on detecting the trigger event; and receiving the multicast transmissions of the multicast session prior to expiration or stopping of the timer.

Example 2 includes the method of example 1 or some other examples herein, wherein the trigger event is a first trigger event, and the method further comprises: detecting a second trigger event; and stopping the timer based on detecting the second trigger event.

Example 3 includes the method of examples 1 or 2 or some other examples herein, wherein the second trigger event includes: detecting an expiration of the timer; receiving an indication that the multicast session is deactivated; receiving a multicast session deactivation notification; performing a cell selection of the cell or an other cell; performing a cell reselection of the other cell; entering an RRC connected state; or entering an RRC idle state.

Example 4 includes the method of examples 1-3 or some other examples herein, further including: terminating said receiving of the multicast transmissions based on detecting the second trigger event; detecting a condition based on terminating said receiving of the multicast transmissions; and initiating an RRC resume procedure based on the condition.

Example 5 includes the method of examples 1-4 or some other examples herein, wherein the condition includes: a reference signal received power being smaller than a first predefined value; or a block error rate being greater than a second predefined value.

Example 6 includes the method of examples 1-5 or some other examples herein, further including: recording data based on detecting the second trigger event or the condition; entering an RRC connected state; and reporting the data via a reporting message.

Example 7 includes the method of examples 1-6 or some other examples herein, wherein: the data includes a time stamp associated with detecting the second trigger event, a failed decoding number, or a channel quality; or the reporting message includes a logged minimization of drive test (MDT) report or a quality of experience (QoE) report.

Example 8 includes the method of examples 1-7 or some other examples herein, wherein the trigger event includes: receiving a configuration to enable an inactive multicast reception; entering the RRC inactive state; receiving a multicast session activation notification in the RRC inactive state; receiving a multicast data scheduling; successfully receiving multicast data; or camping on a cell with the multicast session activated for inactive reception.

Example 9 includes the method of examples 1-8 or some other examples herein, wherein the cell is a first cell and the trigger event includes: determining the multicast session is activated in a second cell; receiving a multicast configuration in the first cell; receiving an indication that the multicast configuration applies in the second cell; or performing cell reselection and camping on the second cell.

Example 10 includes the method of examples 1-9 or some other examples herein, wherein the cell is a first cell, and the trigger event includes: receiving a multicast configuration in the first cell; receiving an indication that the multicast configuration applies in a second cell; performing cell reselection and camping on the second cell; or receiving a multicast session activation notification or a multicast data.

Example 11 includes the method of examples 1-10 or some other examples herein, wherein the cell is a first cell, and the trigger event includes: performing cell reselection and camping on a second cell; or receiving a multicast configuration in the second cell.

Example 12 includes a method of operating a base station (BS), the method including: sending a first message to cause a UE to enter a radio resource control (RRC) inactive state; and sending a second message to configure a timer at the UE, the timer to enable the UE to monitor reception of multicast transmissions of a multicast session while the UE is camped on a cell provided by the base station in the RRC inactive state.

Example 13 includes the method of example 12 or some other examples herein, wherein the multicast session is a first multicast session, the timer is a first timer associated with the first multicast session, and the second message is to further configure a second timer at the UE, the second timer associated with a second multicast session.

Example 14 includes the method of examples 12 or 13 or some other examples herein, wherein the multicast session is a first multicast session and the timer is associated with the first multicast session and a second multicast session.

Example 15 includes the method of examples 12-14 or some other examples herein, wherein the second message is a dedicated RRC message or a broadcast message.

Example 16 includes the method of examples 12-15 or some other examples herein, wherein the second message is a dedicated RRC message, and the method further includes: receiving an RRC resume request message from the UE; sending an RRC release message to the UE; and configuring the timer at the UE in a point-to-multipoint (PTM) configuration of the RRC release message.

Example 17 includes the method of examples 12-16 or some other examples herein, wherein the cell is a first cell, and the method further includes: sending a multicast configuration in the first cell; and sending an indication to the UE that the multicast configuration applies in a second cell.

Example 18 includes the method of examples 12-17 or some other examples herein, wherein the first message configures the UE to receive the multicast transmissions in the RRC inactive state and configures the timer.

Example 19 includes the method of examples 12-18 or some other examples herein, further including: receiving a third message based on expiration of the timer at the UE to indicate termination of receiving the multicast transmissions at the UE.

Example 20 includes the method of examples 12-19 or some other examples herein, wherein the second message is an RRC resume message.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example includes a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method to be implemented by a component of a user equipment (UE), the method comprising:
detecting a trigger event associated with receiving multicast transmissions of a multicast session while the UE is camped on a cell in a radio resource control (RRC) inactive state;
starting a timer at the UE based on detecting the trigger event; and
processing the multicast transmissions of the multicast session prior to expiration or stopping of the timer.

2. The method of claim 1, wherein the trigger event is a first trigger event and the method further comprises:
detecting a second trigger event; and
stopping the timer based on detecting the second trigger event.

3. The method of claim 2, wherein the second trigger event includes:
detecting an expiration of the timer;
processing an indication that the multicast session is deactivated;
processing a multicast session deactivation notification;
performing a cell selection of the cell or an other cell;
performing a cell reselection of the other cell;
entering an RRC connected state; or
entering an RRC idle state.

4. The method of claim 2, further comprising:
terminating said receiving of the multicast transmissions based on detecting the second trigger event;
detecting a condition based on terminating said receiving of the multicast transmissions; and
initiating an RRC resume procedure based on the condition.

5. The method of claim 4, wherein the condition includes:
a reference signal received power being smaller than a first predefined value; or
a block error rate being greater than a second predefined value.

6. The method of claim 4, further comprising:
recording data based on detecting the second trigger event or the condition;
entering an RRC connected state; and
reporting the data via a reporting message.

7. The method of claim 6, wherein:
the data includes a time stamp associated with detecting the second trigger event, a failed decoding number, or a channel quality; or
the reporting message includes a logged minimization of drive test (MDT) report or a quality of experience (QoE) report.

8. The method of claim 1, wherein the trigger event includes:
processing a configuration to enable an inactive multicast reception;
entering the RRC inactive state;
processing a multicast session activation notification in the RRC inactive state;
receiving a multicast data scheduling;
successfully receiving multicast data; or
camping on a cell with the multicast session activated for inactive reception.

9. The method of claim 1, wherein the cell is a first cell and the trigger event comprises:
determining the multicast session is activated in a second cell;
processing a multicast configuration in the first cell;
processing an indication that the multicast configuration applies in the second cell; or
performing cell reselection and camping on the second cell.

10. The method of claim 1, wherein the cell is a first cell, and the trigger event comprises:
processing a multicast configuration in the first cell;
processing an indication that the multicast configuration applies in a second cell;
performing cell reselection and camping on the second cell; or
processing a multicast session activation notification or a multicast data.

11. The method of claim 1, wherein the cell is a first cell, and the trigger event comprises:
performing cell reselection and camping on a second cell; or
processing a multicast configuration in the second cell.

12. One or more non-transitory, computer-readable media having instructions that, when executed by one or more processors, cause a component of a base station to:
send a first message to cause a user equipment (UE) to enter a radio resource control (RRC) inactive state; and
send a second message to configure a timer at the UE, the timer to enable the UE to monitor receptions of multicast transmissions of a multicast session while the UE is camped on a cell provided by the base station in the RRC inactive state.

13. The one or more non-transitory, computer-readable media of claim 12, wherein the multicast session is a first multicast session, the timer is a first timer associated with the first multicast session, and the second message is to further configure a second timer at the UE, the second timer associated with a second multicast session.

14. The one or more non-transitory, computer-readable media of claim 12, wherein the multicast session is a first multicast session and the timer is associated with the first multicast session and a second multicast session.

15. The one or more non-transitory, computer-readable media of claim 12, wherein the cell is a first cell, and the instructions further cause the component of the base station to:
send a multicast configuration in the first cell; and
send an indication to the UE that the multicast configuration applies in a second cell.

16. The one or more non-transitory, computer-readable media of claim 12, wherein the first message configures the UE to receive the multicast transmissions in the RRC inactive state and configures the timer.

17. The one or more non-transitory, computer-readable media of claim 12, wherein the second message is an RRC resume message.

18. An apparatus to be implemented in a user equipment (UE), the apparatus comprising:
processing circuitry to:
detect a trigger event associated with receiving multicast transmissions of a multicast session while the UE is camped on a cell in a radio resource control (RRC) inactive state;
start a timer at the UE based on detecting the trigger event; and
process the multicast transmissions of the multicast session prior to expiration or stopping of the timer; and
interface circuitry coupled with the processing circuitry, the interface circuitry to communicatively couple the processing circuitry to a component of the UE.

19. The apparatus of claim 18, wherein the trigger event is a first trigger event and the processing circuitry is further to:
detect a second trigger event; and
stop the timer based on detecting the second trigger event.

20. The apparatus of claim 19, wherein the processing circuitry is further to:
terminate said receiving of the multicast transmissions based on detecting the second trigger event;
detect a condition based on terminating said receiving of the multicast transmissions; and
initiate an RRC resume procedure based on the condition.
